(19) United States
(12) Patent Application Publication
(10) Pub. No.: US 2007/0178205 A1
(43) Pub. Date: Aug. 2, 2007

(54) ASSEMBLY LINE TECHNIQUE FOR PULL-APART FOOD PRODUCTION

(75) Inventors: Nancy KIRKSEY, Irvine, CA (US); Scott FITZGERALD, Huntington Beach, CA (US)

Correspondence Address: PAUL, HASTINGS, JANOFSKY & WALKER LLP, P.O. BOX 919092, SAN DIEGO, CA, 92191-9092, US

(73) Assignee: Sweet Life, Inc., Santa Ana, CA (US)

(21) Appl. No.: 11/457,218

(22) Filed: Jul. 13, 2006

Related U.S. Application Data
(60) Provisional application No. 60/763,857, filed on Jan. 31, 2006.

(51) Int. Cl. A23P 1/00

(52) U.S. Cl. 426/518

(57) ABSTRACT

An assembly line technique is described in which food items with a sticky deposited layer of smear prior to baking can be cut and segregated into small pieces. In an embodiment of the invention, an ultrasonically driven knife is used to cut strips of dough having sticky smear deposited on top into square portions. An ultrasonic knife prevents the smear from sticking to the knife blade resulting in clean cut edges of the food pieces and efficient mass production. The food pieces are deposited randomly into a serving container in such a way as to minimize contact between the sticky smear surfaces of the food pieces. This results in a “pull-apart” food product that can be rapidly microwave heated without drying or overheating the areas of the overall food product.

### CROSS-REFERENCE TO RELATED APPLICATION

The present patent application claims priority to U.S. Provisional Patent Application No. 60/763,857, filed Jan. 31, 2006, and entitled “Assembly Line Technique for Pull-Apart Food Production,” the entire disclosure of which is incorporated by reference herein.

### BACKGROUND OF THE INVENTION

1. Field of Invention

The present invention relates generally to the field of food production and more specifically, to an assembly line technique for the cutting and segregation of sticky food.

2. Description of Related Art

There are many food items on the market which have inherent bulk stickiness or a sticky coating or layer. Food items with inherent bulk stickiness include, but are not restricted to, cheeses, cheesecakes, pies, and brownies. Food items with sticky coatings or layers include, but are not restricted to, cakes, cookies, donuts, and cinnamon rolls. Many of these food items are sold to the consumer in whole form requiring that the consumer cut and segregate individual servings of the food with a kitchen utensil such as a knife. Nowadays, these food items tend to be pre-sliced before they reach the customer.

In the case of a food item having a sticky component, the bakery or supplier typically utilizes a knife dipped in hot water or a wire under tension to cut, i.e., slice, whole food items into separate portions for individual consumption. The use of a thin narrow bladed knife or wire under tension is advantageous because a reduction in the contact area between the knife and the sticky material provides a relatively cleaner cut than in the case of a thicker, broader knife blade. Nevertheless, if the same knife or tensioned wire utensil is used repeatedly to cut or slice multiple same or similar food items, the sticky component of the food item accumulates on the utensil over time, thereby requiring the utensil to be cleaned in order to facilitate continued usage. Repeated cleaning of the utensil presents a problem in bakeries or food preparation settings where high output and/or high efficiency food production is desired.

In an attempt to circumvent such a problem, bakeries sandwich a sticky layer or component between two relative non-sticky layers such as dough. For example, a cinnamon roll is essentially a sticky cinnamon paste sandwiched between dough, which is then rolled over onto itself. When slicing a cinnamon roll, the cutting utensil enters and leaves the roll touching dough and not the cinnamon paste. The dough on the outside of the roll helps prevent the sticky paste inside from adhering to the cutting utensil, thereby increasing production efficiency. However, such a benefit is usually gained by sacrificing convenience when baking or reheating the end food product. For example, cinnamon rolls are not microwave friendly as the roll and the filling typically heat at very different rates resulting in an undesirable product for consumption.

### SUMMARY OF THE INVENTION

The present invention overcomes these and other deficiencies of the prior art by providing an automated assembly line technique that efficiently cuts and segregates, for example, dough having a sticky food substance on the top or outside. The cut and segregated pieces of dough with a sticky layer on top are assembled into a container as a “pull-apart” food item. The pull-apart food item may then be microwave heated relatively quickly and thoroughly without the areas of the item becoming dry or overheated.

In an embodiment of the invention, a food production assembly line system comprises: a divider for separating a food sheet into multiple longitudinal strips, and a non-stick cutter for cutting said multiple longitudinal strips into individual pieces, wherein said non-stick cutter cuts said multiple longitudinal strips substantially perpendicular to a longitudinal axis of said multiple longitudinal strips. A hopper may be included for applying a smear to a surface of said multiple longitudinal strips. The food sheet may be dough. The non-stick cutter may be an ultrasonic knife. The individual pieces with smear may be rectangular shaped. The assembly line system may further include a means for arranging a number of said individual pieces into a serving container such that contact between sticky smear on the top surfaces of said pieces is randomized.

In another embodiment of the invention, a food item assembly method comprises the steps of: separating a sheet of dough into multiple strips, applying a smear to a surface of said multiple strips, and cutting said multiple strips with applied smear into individual pieces. The method may further comprise the step of accumulating a number of said individual pieces into a container, wherein said step of accumulation is randomly performed such that contact between the smear surfaces of said individual pieces is minimized.

In yet another embodiment of the invention, a pull-apart food item comprises: multiple individual pieces of dough, and smear applied to a surface of each of said multiple individual pieces of dough. The multiple individual pieces of dough with applied smear are randomly arranged to minimize contact between smear surfaces and are pre-baked and frozen.

In yet another embodiment of the invention, a method for serving a pull-apart food item comprises the steps of: receiving a pull-apart food item, wherein said pull-apart food item comprises multiple individual pieces of dough and smear applied to a surface of each of said multiple individual pieces of dough, and heating said pull-apart food item to a serving temperature. The pull-apart food item is contained within a microwaveable serving cup.

An advantage of the present invention is realized in the use of an ultrasonic guillotine knife blade which prevents the unbaked dough pieces with added sticky layer from sticking to the knife resulting in clean cut ends of the pieces without an affinity for self adhesion until a second faster running conveyor belt can segregate the items. The technique is particularly advantageous when cutting and segregating small pieces.

An advantage also results from the random placement of small pieces into a container prior to baking. Random placement ensures that the majority of the small pieces will not touch one another fully at their sticky interfaces. The result after baking and reheating is the removal of the food from the container almost assuredly as individual small pieces for eating and not a large cluster of pieces stuck together.

The foregoing, and other features and advantages of the invention, will be apparent from the following, more particular description of the preferred embodiments of the invention, the accompanying figures, and the claims.

### BRIEF DESCRIPTION OF THE FIGURES

For a more complete understanding of the present invention, the objects and advantages thereof, reference is now made to the ensuing descriptions taken in connection with the accompanying figures briefly described as follows:

FIG. 1 illustrates an assembly line system for preparing a pull-apart food item according to an embodiment of the invention;

FIG. 2 illustrates pull-apart food items in a heatable serving cup resulting from the assembly line system according to an embodiment of the invention;

FIG. 3 illustrates an automated system for randomly placing the food pieces in a heatable cup;

FIG. 4 illustrates an alternative strip cutting system as implemented for the assembly production of small pieces of food having a bulk stickiness.

### DETAILED DESCRIPTION OF EMBODIMENTS

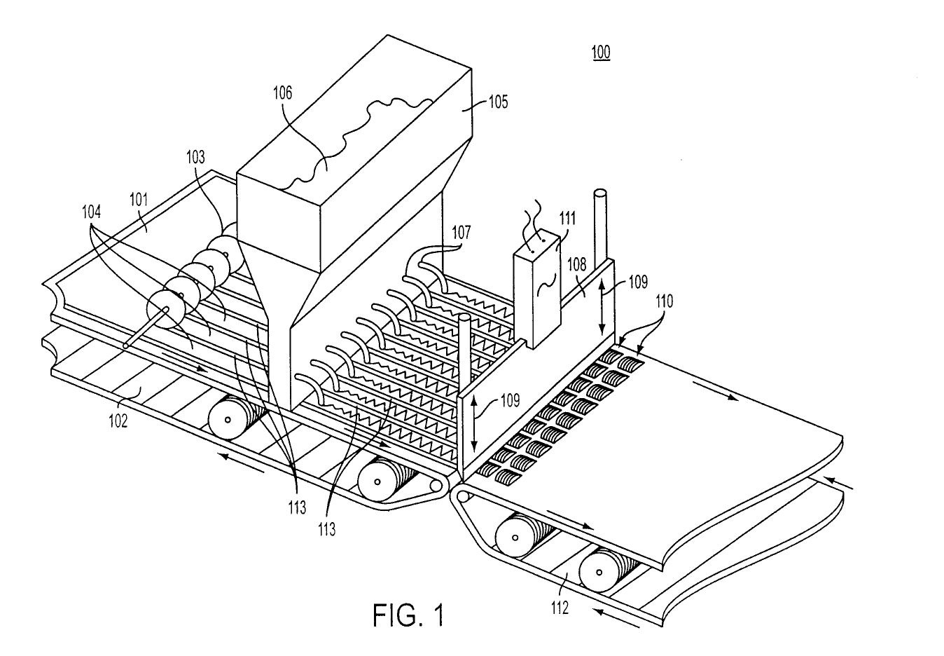

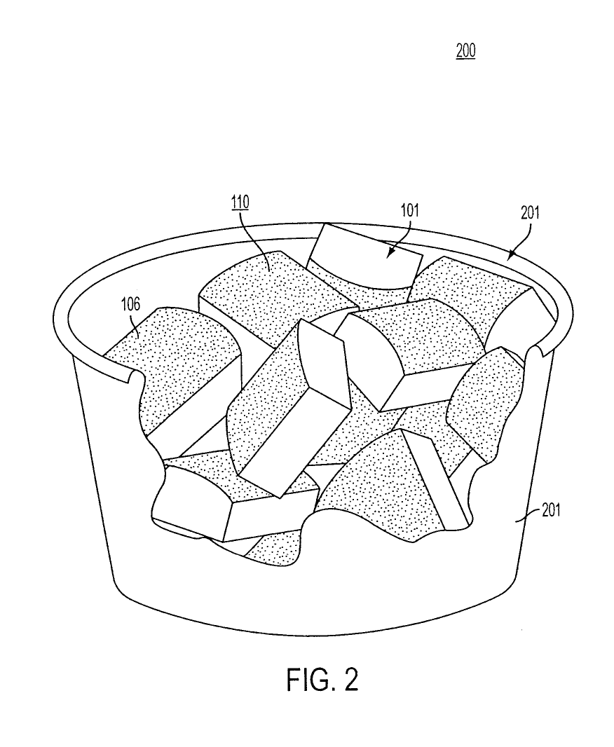

Embodiments of the present invention and their advantages may be understood by referring to FIGS. 1-4, wherein like reference numerals refer to like elements and are described in the context of preparing a “pull-apart” food item. Nonetheless, the improvements described herein are applicable to the preparation of any type of food item having a component which tends to stick or accumulate on conventional cutting, segregating, or slicing utensils.

The present invention is particularly well suited for preparing a pull-apart food item. A “Pull-apart” food as used herein refers to a food item comprising a number of individual food pieces that although presented together as a whole may be easily separated from one another, i.e., pulled apart by hand or by a utensil such a fork after heating. For example, a pull-apart food may comprise a number of dough pieces covered with a cinnamon paste or smear on one side, e.g., the top surface, thereby forming a “cinnamon pull apart.” By only applying the cinnamon smear to the top surface of each piece, the overall food product can be pre-baked, frozen, and then re-heated again more evenly in a microwave oven.

FIG. 1 illustrates an assembly line 100 for preparing a pull-apart food item according to an embodiment of the invention. The assembly line 100 comprises: conveyor belts 102 and 112, a strip cutting system 103, a hopper 105, a plurality of dispensing tubes 107, an ultrasonic knife 108, and an ultrasonic transducer 111. In operation, a slab of dough 101 is moved on the conveyor belt 102, which is shown as moving clockwise in the figure. The strip cutting system 103 comprises multiple knives, preferably circular in shape in order to roll and cut the slab of dough 101 along the conveyor 102 into multiple parallel longitudinal strips 104 with enough space 113 between adjacent dough strips 104 to maintain separation once cut and moved past the knives 103. In an exemplary embodiment of the invention, the dough is cut into twelve strips 104 (although only nine are shown) of equal width by eleven knives 103 appropriately spaced apart.

Once past the strip cutting system 103 the strips pass under a hopper 105 containing a smear 106, which generally is sticky in nature, such as a cinnamon smear. The flow controlled dispensing tubes 107 attached to the bottom portion of the hopper 105 deposit the smear 106 on the top surface of each dough strip 104. The flow of the smear 106 and the linear speed of the conveyor 102 are maintained at predetermined values, the determination of which is apparent to one of ordinary skill in the art, to assure an evenly dispensed amount of the smear 106 on the top of each strip by the time the strips 104 arrive at the ultrasonic knife 108. The ultrasonic knife 108 is moved up and down, as indicated by the double headed arrows 109. The up and down cycle of the knife 108 is chosen such that a desired length of the resulting pieces of dough with their top sticky material 110 results. In an exemplary embodiment, the resulting pieces 110 are approximately one inch in length, one inch wide, and one inch thick.

The use of an ultrasonic knife alleviates the problem of the sticky smear 106 sticking to and accumulating on the blade of knife 108. Without the top laden sticky material on each strip the normal cutting action of the knife blade by itself would be sufficient to isolate each end portion of the pieces as properly floured dough generally does not stick to a metal knife blade. Likewise, if the smear 106 was not sticky it would not likely accumulate on the knife 108 when placed on top of the strips 104. However, because of the presence of a sticky smear 106 on top of the strips 104, repeated clean cuts of the pieces are foiled by eventual deposits of the sticky smear on the surface of the knife blade. This problem is alleviated by the incorporation of the ultrasonic transducer 111 attached to the blade of the knife 108. The ultrasonic vibration of the knife 108 effectively prevents the deposit of the sticky smear 106 on the knife, thereby resulting in clean straight end cuts as well as the elimination of any need to stop the assembly line 100 and clean the knife 108. Thus, fast and efficient production of the pull-apart constituents 110 is achieved. The use of the ultrasonic knife 108 also eliminates the existence of stringy filaments of sticky material between the food pieces and the knife and between the food pieces themselves.

In order to effect longitudinal separation between the cut pieces 110, the knife 108 is placed over a second conveyor belt 112 butted end-to-end with the first conveyor belt 102 according to an embodiment of the invention. The conveyor belt 112 is operated at a linear speed faster than that of the conveyor belt 102 resulting in a pulling apart of the pieces assuring no possible end-to-end self adhesion of neighboring food pieces 110. For example, the conveyor belt 112 may operate at a speed which is 20% faster than the speed of the conveyor belt 102.

The cut food pieces 110 resulting from the described assembly line 100 are either manually and/or automatically placed into containers. FIG. 2 illustrates a container configuration 200 according to an embodiment of the invention. Particularly, the container configuration 200 comprises an individual serving cup 201 with a number of randomly placed pull-apart food items 110, each comprising dough 101 with a topside smear 106 resulting from the assembly line system 100.

The manual placement of the pieces 110 into the cup 201 involves the use of one or more persons removing the pieces 110 from the conveyor belt 112 and randomly placing them into the cup 201. In an exemplary embodiment of the invention, twelve pieces 110 are randomly placed into a cup to minimize contact between the sticky smear surfaces 106 of the pieces 110. It has been unexpectedly found through experiment that randomly minimized contact between the sticky smear surfaces 106 results in more efficient microwave heating of the overall food item.

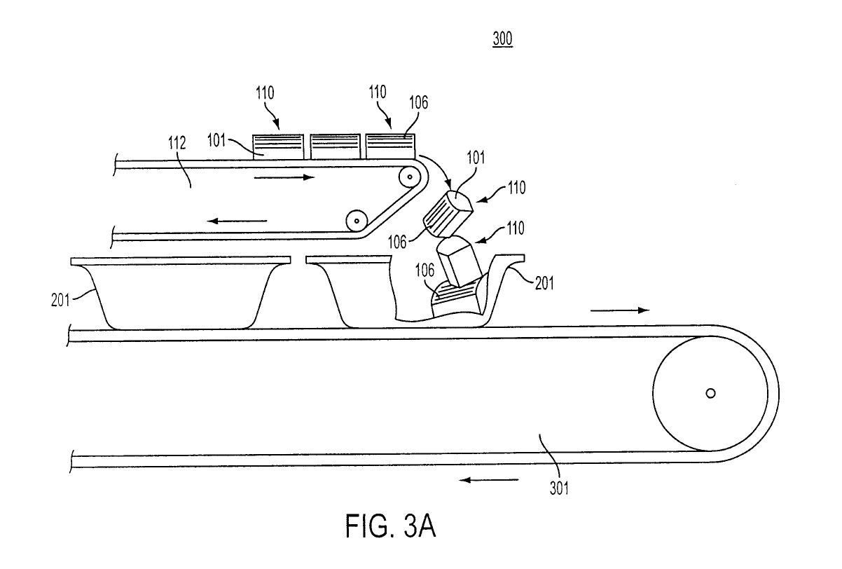

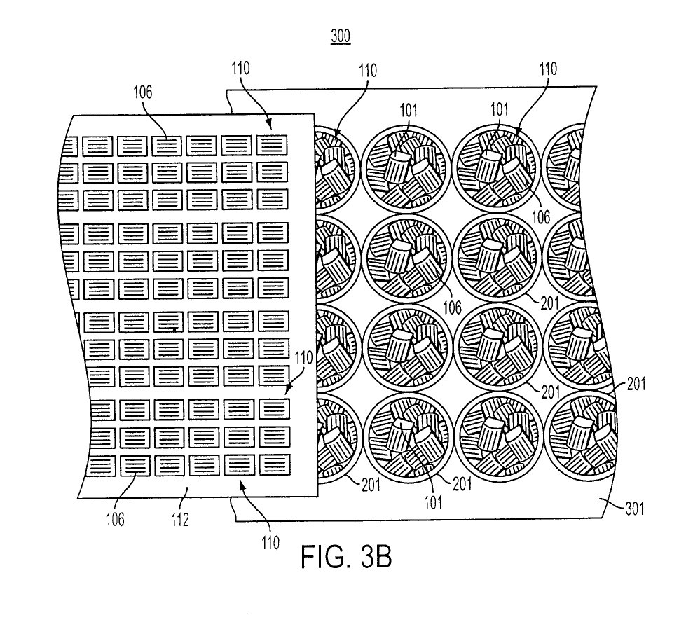

FIG. 3 illustrates an automated system 300 for randomly placing the food pieces in the cup 201 according to an embodiment of the invention. FIG. 3a illustrates a cross sectional side view of this system and FIG. 3b illustrates a top down view of the same system. The automated system 300 comprises a conveyor 301 wherein multiple cups 201 are placed and moved along such. Referring to FIG. 3a, one linear row of pull apart food pieces 110 are shown conveyed along on the conveyor 112. In reality there are more rows as shown in FIG. 3b, where twelve rows are shown for an exemplary case. The pieces 110 are allowed to fall under gravity off the conveyor 112 at its terminus and tumble randomly into the containers 201. Containers 201 are transported left to right by the conveyer 301 below conveyor 112 and the containers 201 are moved at a linear speed such that the food pieces fall into it from the right to left position thereby distributing stacked food pieces 110 over the inside volume of the container 201. One cut-away container 201 is shown in the process of being filled, but in reality a row of containers 201 perpendicular to the plane of the figure are simultaneously being filled as shown in the top down view of FIG. 3b. In the example shown, each container 201 in a row can except up to 3 rows of food pieces 110 at a time and in this exemplary configuration be made to accept twelve pieces of randomly placed food items 110 in each container 201. FIG. 3a also shows that empty containers 201 are placed in a row along the conveyor belt 301. The filled containers 201 are either removed manually from the conveyor 301 or by automatic means such as, but not limited to a robotic arm.

In another embodiment, the automation may be accomplished through the use of a “pick and place” method. In this embodiment a replaceable pick much like a toothpick is mounted onto a robotic arm. The pick is stuck into the food piece 110, the food piece 110 then moved over the container 201, shaken loose, and allowed to randomly fall into the container. An electromechanical actuator or a similar system connected to the robotic arm causes this shaking action. Several robotic arms with such picks in place can be used to load several containers 201 simultaneously.

In an embodiment of the invention, the dough is prepared from a commercially available dough mix, cinnamon roll mix, or the like.

In an embodiment of the invention, the smear is prepared from a commercially available smear mix such as a cinnamon smear. One of ordinary skill in the art recognizes that a cinnamon smear is exemplary only. Other exemplary smears include, but are not limited to chocolate, grape, strawberry, orange, sugar, cream cheese, or even a combination thereof. In an alternative embodiment of the invention, a topping could be substituted for the smear. The topping may comprise one or more layers such as cheese, pepperoni, etc. as for the case of bite size pizza pieces.

In another embodiment of the invention, the container configuration 200 with pull-apart food items 110 contained therein is baked and then cooled in a blast freezer, and then shipped to a food establishment or restaurant. The food establishment or restaurant reheats the pull-apart food item to a serving temperature, preferably using a microwave oven. Experimental results have shown that 12 pieces 110 within an individual serving cup 201 can be reheated to an adequate serving temperature within 14 seconds for an approximately 1000 Watt microwave oven.

In an embodiment of the invention, baking occurs for ten to fourteen minutes in an oven heated to 325-375 degrees Fahrenheit. Icing may be applied after baking and before blast freezing.

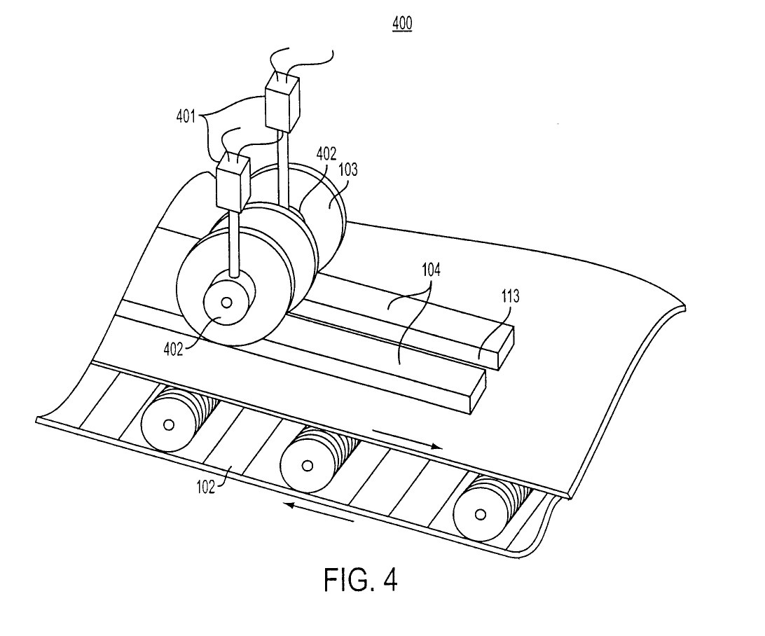

FIG. 4 illustrates an alternative strip cutting system 400 as implemented for the assembly production of small pieces of food having bulk stickiness. For food with bulk stickiness the sticking of the food to the strip cutting system blades becomes an added problem to the assembly production to that described for the food with a sticky film. To alleviate this problem the strip cutting system 103 is outfitted with ultrasonic transducers 401 in a similar fashion to the previously described guillotine knife. In the case of the strip cutting system 103, the ultrasonic transducers 401 would be attached to system support members 402 at the ends and in between the blades if needed. The ultrasonically driven strip cutting system would also assist in the cutting of bulk sticky food in which the inherent surface tension of the uncooked dough is inoperative and a space 113 between strips 104 still needs to be enacted.

The size of the food pieces resulting from any of the embodiments described include, but are not limited to, small bite size pieces, sizes in proportion to the eating habits of individual humans, and any number of larger dimensions.

The present embodiments do not preclude the described method from being used in any situation in which there is the need for cutting and segregating pieces of bulk sticky materials or materials with a sticky layer. The use of such materials includes, but is not limited to, home appliance, automotive, and marine applications.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalence.

What is claimed is:

1. A food production assembly line system comprising:
a divider for separating a food sheet into multiple longitudinal strips, and
a non-stick cutter for cutting said multiple longitudinal strips into individual pieces,
wherein said non-stick cutter cuts said multiple longitudinal strips substantially perpendicular to a longitudinal axis of said multiple longitudinal strips.

2. The system of claim 1, further comprising a hopper for applying a smear to a surface of said multiple longitudinal strips.

3. The system of claim 1, wherein said food sheet comprises dough.

4. The system of claim 1, wherein said non-stick cutter comprises an ultrasonic knife.

5. The system of claim 2, wherein said individual pieces with smear are rectangular shaped.

6. The system of claim 2, further comprising means for arranging a number of said
individual pieces into a serving container such that contact between sticky smear on
the top surfaces of said pieces is randomized.

7. A food item assembly method comprising the steps of:
separating a sheet of dough into multiple strips,
applying a smear to a surface of said multiple strips, and
cutting said multiple strips with applied smear into individual pieces.

8. The method of claim 7, further comprising the step of accumulating a number of said
individual pieces into a container.

9. The method of claim 8, wherein said step of accumulation is randomly performed such that contact between the smear surfaces of said individual pieces is minimized.

10. A pull-apart food item comprising:
multiple individual pieces of dough, and
smear applied to a surface of each of said multiple individual pieces of dough.

11. The food item of claim 10, wherein said multiple individual pieces of dough with applied smear are randomly arranged to minimize contact between smear surfaces.

12. The food item of claim 10, wherein said multiple pieces of dough with applied smear are baked and frozen.

13. A method for serving a pull-apart food item comprising the steps of:
receiving a pull-apart food item, wherein said pull-apart food item comprises multiple
individual pieces of baked dough and smear applied to a surface of each of said multiple individual pieces of baked dough, and
heating said pull-apart food item to a serving temperature.

14. The method of claim 13, wherein said pull-apart food item is contained within a microwaveable serving cup.
